(19) United States
(12) Patent Application Publication
(10) Pub. No.: US 2018/0032682 A1
(43) Pub. Date: Feb. 1, 2018

(54) Systems and Methods for Measuring and Managing a Physiological-Emotional State

(71) Applicant: Biosay, Inc., Newton, MA (US)

(72) Inventor: Rachael Donalds, Sudbury, MA (US)

(21) Appl. No.: 15/661,803

(22) Filed: Jul. 27, 2017

Related U.S. Application Data
(60) Provisional application No. 62/367,365, filed on Jul. 27, 2016.
(60) Provisional application No. 62/455,153, filed on Feb. 6, 2017.

(51) Int. Cl. G06F 19/00

(52) U.S. Cl. CPC G06F 19/322; G06F 19/3406; G06F 19/321

(57) ABSTRACT

Methods and systems are provided herein for measuring a physiological-emotional state of a user and include acquiring user data one of physiological data, emotional affect data, or a combination of both, receiving the user data from the mobile device, determining, by a processor of the central computing device, a user state from the physiological data, the emotional affect data, or a combination of both, quantifying, by the processor, the user state to identify a physiological-emotional state of the user, and presenting a graphical representation of the physiological-emotional state of the user on a display device

### FIELD

This application claims the benefit of and priority to U.S. Provisional Application No. 62/367,365, filed Jul. 27, 2016, which is hereby incorporated herein by reference in its entirety. This application also claims the benefit of and priority to U.S. Provisional Application No. 62/455,153, filed Feb. 6, 2017, which is hereby incorporated herein by reference in its entirety.

### FIELD

The present invention relates in general to the field of health monitoring and in particular to measuring and managing a physiological-emotional state of a user.

### BACKGROUND

Biometric data generally includes any electronic data captured in relation to a biological organism or process. Biometric data is conventionally used in connection with security systems, electronic human identification, health monitoring, and fitness monitoring. However, such conventional systems are of limited utility for psychological and psychiatric applications.

### SUMMARY

In some embodiments, a method for measuring a physiological-emotional state of a user is provided. The method includes acquiring, by a mobile device, user data including one of heart rate data, facial image data, or a combination of both. The method also includes receiving, at a central computing device, the user data from the mobile device. The method also includes determining, by a processor of the central computing device, one of user heart rate variability from the heart rate data, user emotional state from the facial image, or a combination of both. The method also includes combining, by the processor, the heart rate variability and emotional state of the user to identify a physiological-emotional state of the user. The method also includes generating a graphical representation of the physiological-emotional state of the user.

In some embodiments, a system for measuring a physiological-emotional state of a user is provided. The system includes a mobile device configured to acquire user data including one of heart rate data, facial image data, or a combination of both. The system also includes a central computing device configured to receive the user data from the mobile device. The central computing device includes a processor. The central computing device also includes a memory.

The memory includes instructions that, when executed by the processor, cause the system to determine one of user heart rate variability from the heart rate data, user emotional state from the facial image, or a combination of both. The memory also includes instructions that, when executed by the processor, cause the system to combine, by the processor, the heart rate variability and emotional state of the user to identify a physiological-emotional state of the user. The memory also includes instructions that, when executed by the processor, cause the system to generate a graphical representation of the physiological-emotional state of the user.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 is block diagram illustrating a system for measuring a physiological-emotional state of a user in accordance with various embodiments.

FIG. 2 is an x-y plot illustrating a plot for synthesizing heart rate variability data with emotional state data in accordance with various embodiments.

FIG. 3 is a flow diagram illustrating a method for measuring a physiological-emotional state of a user in accordance with various embodiments.

FIG. 4 is a block diagram illustrating an example computing device in accordance with various embodiments.

FIG. 5 is a block diagram illustrating an example user device in accordance with various embodiments.

FIG. 6 is a representation of an augmented reality interface of a system for measuring a physiological-emotional state of a user in accordance with various embodiments.

FIG. 7 is a representation of a map interface of a system for measuring a physiological-emotional state of a user in accordance with various embodiments.

FIGS. 8A-8D are examples of graphical representations of a physiological-emotional state of a user or users in accordance with various embodiments.

FIG. 9 is a data flow diagram illustrating data flow of a system for measuring a physiological-emotional state of a user in accordance with various embodiments.

While the above-identified drawings set forth present disclosure, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the present disclosure.

### DETAILED DESCRIPTION

Reference will now be made in detail to the preferred embodiments of the present invention, examples of which are illustrated in the accompanying drawings. The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

Reference in this specification to “an embodiment” or “the embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Heart rate variability (HRV), also known as R-R variability or N-N variability, as used herein, refers to a measure of variation in a beat-to-beat time interval between heartbeats. HRV, in accordance with various embodiments, can generally be defined as a difference between adjacent time intervals associated with a series of heartbeats. For example, if a first time interval between a first beat and a second beat is 450 ms and a second time interval between the second beat and the third beat is 820 ms, the HRV is 370 ms. In some embodiments, HRV can be measured as an average HRV over time (e.g., an average of a plurality of HRV readings over a preset heart rate data collection period).

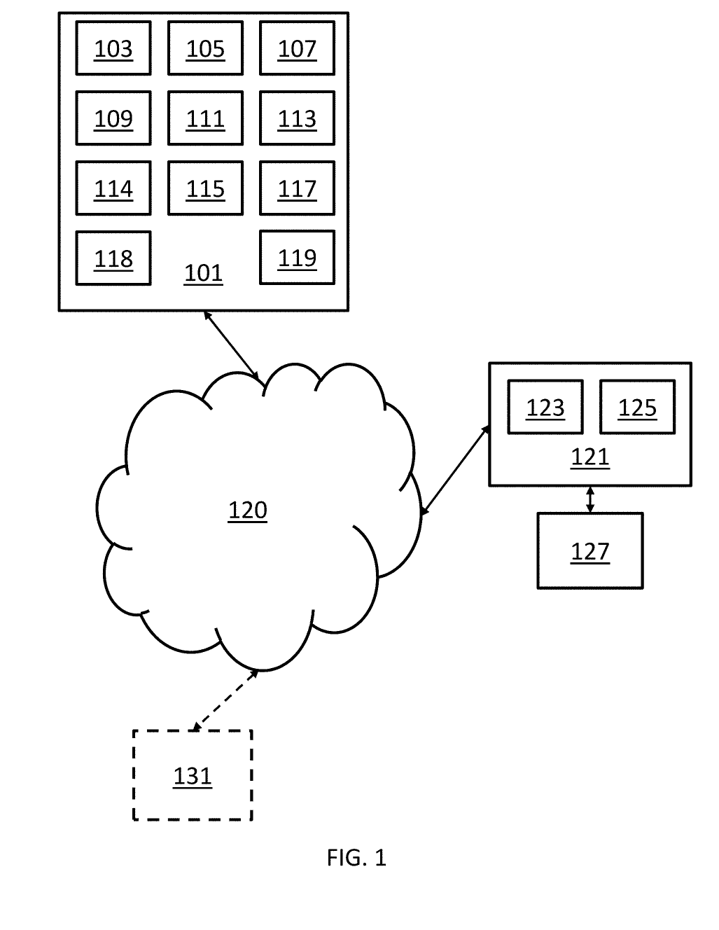

Referring now to FIG. 1, a system 100 for measuring a physiological-emotional state of a user, in accordance with various embodiments, includes a mobile device 101 configured to acquire biometric user data (e.g., heart rate data, facial image data, voice pattern data, bioelectric data) and transmit the user data, for example, using communications device 107. The system 100 also includes a central computing device 121 configured to receive the user data transmitted from the mobile device 101. In accordance with various embodiments, the central computing device 121 can receive the user data from the mobile device 101 via a communications network 120.

The system 100, in response to receiving the user data, can determine a physiological state of the user, an emotional state of the user, or combinations thereof. For example, in one embodiment, the system 100 can determine user heart rate variability (HRV) from received heart rate data and user valence (emotional affect) from one or more of received facial image data or received voice pattern data. The system 100, in some embodiments, can combine the physiological state and the emotional state (e.g., heart rate variability (HRV) and valence) of the user to identify a physiological-emotional state of the user. The system 100, in accordance with various embodiments, can generate a graphical representation of the determined physiological-emotional state of the user. It will be apparent in view of this disclosure that, in accordance with various embodiments, each of these functions can be performed by mobile device 101 (e.g., by a processor 103 of the mobile device 101), by the central computing device 121 (e.g., by a processor 123 of the central computing device 121), or can be performed cooperatively by the mobile device 101 and the central computing device 121. It will further be apparent in view of this disclosure that the user data and the representation of the user's physiological-emotional state can be stored, for example, in either or both of a memory 105 of the mobile device 101 or a memory 125 of the central computing device 121.

In accordance with various embodiments, one the mobile device 101, the central computing device 121, or both can also retrieve external data from, or send user data or event records to, for example, an external database 131 to retrieve additional data or inform one or more third parties as discussed in greater detail below. In some embodiments, the system 100 can then store the user data, the physiological-emotional state of the user, and a time stamp associated with a time of acquisition of the user data as an event record in either or both of the memory 105 of the mobile device 101 or the memory 125 of the central computing device 121. In accordance with various embodiments, the event record can be added to a historical database including a plurality of historical event records.

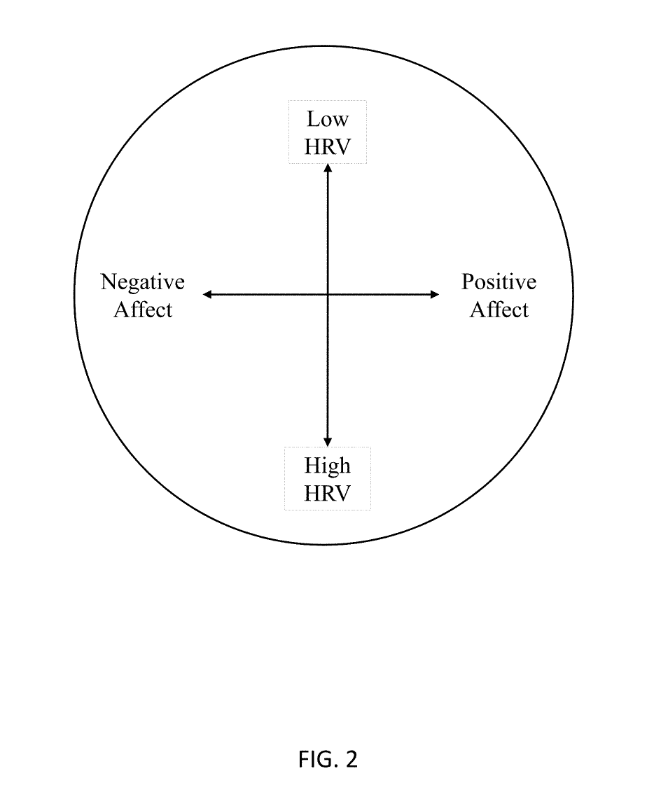

In accordance with various embodiments, a physiological-emotional state can be determined by plotting the user HRV in relation to the user emotional state (also referred to as valence) along a plot as shown in FIG. 2. In the example illustrated by FIG. 2, high HRV (i.e., higher variation in the interval between heartbeats) is plotted along the positive vertical (y) axis, low HRV (i.e., little variation in the interval between heartbeats) is plotted along the negative vertical (y) axis, negative emotional affects are plotted along the negative horizontal (x) axis, and positive emotional affects are plotted along the positive horizontal (x) axis. Thus, as shown in FIG. 2, user HRV and user emotional affects can be plotted as two-dimensional physiological-emotional states. However, although FIG. 2 depicts a two-dimensional determination of physiological-emotional state wherein HRV is plotted against emotional affect, it will be apparent in view of this disclosure that the dimensions for determining physiological-emotional state can be determined according to any number of selected physiological and/or emotional state input factors. For example, in some embodiments, physiological and/or emotional state input factors can include, but are not limited to, one or more of emotional state/valence, heart rate variability (HRV), arousal level, heart rate, user body temperature, electrical brain activity data (e.g., as measured by an EEG), vocal pattern data, electrodermal activity, variation in pupil dilation, fluctuations in skin tone or coloration, fluctuations in blood pressure, or combinations thereof.

It will further be apparent in view of this disclosure that, although FIG. 2 depicts a two-dimensional determination of physiological-emotional state, any number of dimensions can be used to determine physiological-emotional state. In some embodiments, for example, a third dimension, plotted, for example, along a (z) axis (not shown) can indicate an arousal level of the user (e.g., by measuring heart rate). In such embodiments, for example, the user arousal level, the user affect, and/or the user HRV can be used to determine a current physiological-emotional state of the user. Then, for example, if the user elects to participate in a biofeedback exercise, one or more of the user arousal level, the user affect, the user HRV, or combinations thereof can be used to monitor and track improvement of the user's physiological-emotional state during the biofeedback exercise.

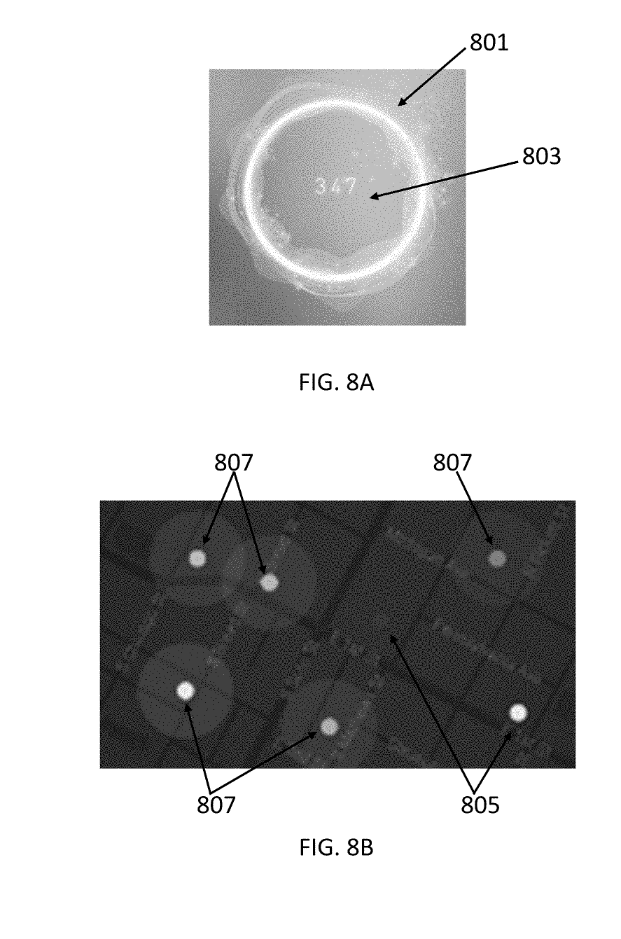

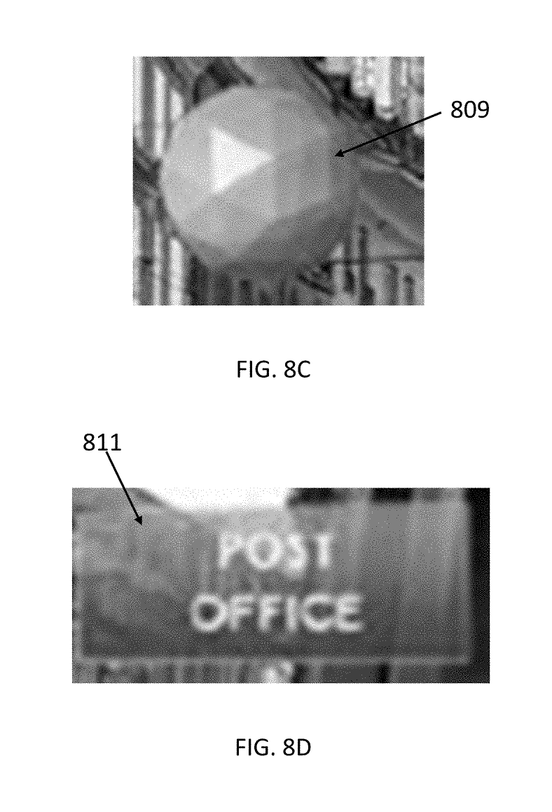

The representation of the physiological-emotional state, in accordance with various embodiments, can be any graphical, pictorial, video, animated, or auditory representation or combinations thereof. For example, FIGS. 8A-8D illustrate various graphical representations 801, 805, 807, 809, 811 of a physiological-emotional state. As shown in FIG. 8A, in one embodiment, the graphical representation 801 can include a colored, stylized ring. In some embodiments, the colors and/or the size and shape of the stylized portion of the ring can indicate the physiological-emotional state of the user or users. The graphical representation 801 can also include a center portion 803. As shown in FIG. 8A, the center portion 803 can display a numerical or textual physiological-emotional score. However, it will be apparent in view of this disclosure that, in accordance with various embodiments, the center portion 803 can include any other content for presentation to the user or users. For example, the center portion 803 can display one or more of advertisements, signage, images, videos, text, colors, hyperlinks, audio players, video players, any other audio/visual content, or combinations thereof.

As shown in FIG. 8B, in one embodiment, the graphical representation 805 can include a colored dot, wherein a size, color, and/or intensity of the dot can indicate the physiological-emotional state of the user or users. Also as shown in FIG. 8B, in one embodiment, the graphical representation 807 can include a pulsing or flashing colored dot, wherein a size, color, and/or intensity of the dot can indicate the physiological-emotional state of the user or users. In some embodiments, the pulse or flash rate of the colored dot can correspond to a physiological and/or emotional measurement associated with the user or users (e.g., heart rate).

As shown in FIG. 8C, in one embodiment, the graphical representation 809 can include a two or three-dimensional geometric object having one or more colors, wherein the colors and color proportions of the geometric object can indicate the physiological-emotional state of the user or users. As shown in FIG. 8D, in one embodiment, the graphical representation 811 can include a sign object having one or more colors, wherein the colors and color proportions of the sign object can indicate the physiological-emotional state of the user or users.

The mobile device 101, in accordance with various embodiments can include, for example, at least one of a cellphone, a smartphone, a personal digital assistant (PDA), a laptop, a tablet, a wearable device, any other portable electronic device suitable for acquiring user data, or combinations thereof. The mobile device 101 can, in accordance with various embodiments, include one or more of a processor 103 and a memory 105. The mobile device 101 can also include a communications device 107 for providing electronic communications with, for example, the network 120. The mobile device 101, in accordance with various embodiments, can also include one or more of an image sensor 109 for acquiring image data, a light source 111 for illuminating a subject, a magnetic sensor 113 for detecting magnetic fields, an electrical sensor 114 for acquiring bioelectric data, an audio sensor 115 for acquiring audio data, a display 117 for presenting a graphical user interface to the user, a text analysis module 118, a GPS module 119 for determining a location of the mobile device 101, or combinations thereof.

The processor 103 can include, for example, at least one of a microprocessor, a CPU, a field-programmable gate array (FPGA), a microcontroller, single core processors, multi-core processors, or combinations thereof. The memory 105, in accordance with various embodiments, can include, for example, at least one of a magnetic storage disk, a hard disk drive (HDD), an optical disk, flash memory, random-access memory (RAM), DRAM, SRAM, EDO RAM, a solid state drive (SSD), or combinations thereof.

The communications device 107 can include, for example, at least one of a built-in network adapter, an antenna, a transceiver, a radio-frequency (RF) transceiver, a near-field communications (NFC) module, a Bluetooth module, a Wi-Fi transceiver, a network interface card, a PCMCIA network card, a card bus network adapter, a wireless network adapter, a USB network adapter, a modem, any other suitable devices for connecting to the network 120, or combinations thereof. In accordance with various embodiments, the communications device 107 can, for example, transmit the user data to the central computing device 121, receive data from the network 120 or the central computing device 121, or transmit or receive data to/from any other source.

The image sensor 109 can include, for example, at least one of a charge-coupled device (CCD), an active-pixel sensor (APS), CMOS APS, NMOS APS, an infrared sensor, a focal plane array, a digital camera, a digital video camera, or combinations thereof. In some embodiments, the mobile device 101 can acquire the user data by use of the image sensor 109. For example, the image sensor 109 can be used to acquire still or videographic imagery of a user's face. The imagery can then be analyzed (e.g., by facial recognition software stored in the memory 105 of the mobile device 101 or the memory 125 of the central computing device 121) to determine (e.g., by the processor 103 of the mobile device 101 or the processor 123 of the central computing device 121) one or both of the heart rate data or the user emotional state. In one example, the facial recognition software can detect and classify a user's facial expression to determine emotional state. In another example, the facial recognition software can detect and monitor one or more blood vessels within the image data to determine a pulse rate and/or HRV associated therewith. In another example, the facial recognition software can detect pupil dilation and changes thereto to determine an arousal level and/or an emotional state of the user. Furthermore, based on the imagery acquired by the image sensor 109, the system 100 can, in some embodiments, determine ambient colors, lighting levels, and background content which can be associated with the event record in the memory 105, 125 for providing context to the user's physiological-emotional state.

The light source 111 can include, for example, at least one of an incandescent bulb, a laser, a light emitting diode (LED), a compact fluorescent bulb (CFL), a fluorescent bulb, any other suitable light source, or combinations thereof. In accordance with various embodiments, user heart rate data can be acquired by illuminating a finger of the user with the light source 111 while recording the finger at close range with the image sensor 109. The recording can then be analyzed (e.g., by the processor 103 of the mobile device 101 or the processor 123 of the central computing device 121) to detect blood moving through the finger and, therefrom, a heart rate variability of the user.

The magnetic sensor 113 can include, for example, at least one of a Hall effect sensor, a magneto-diode, a magneto-transistor, an AMR magnetometer, a GMR magnetometer, a magnetic tunnel junction magnetometer, a magneto-optical sensor, a Lorentz force based MEMS sensor, an Electron Tunneling based MEMS sensor, a MEMS compass, a nuclear precession magnetic field sensor, an optically pumped magnetic field sensor, a fluxgate magnetometer, a search coil magnetic field sensor, a SQUID magnetometer, or combinations thereof. In some embodiments, the mobile device 101 can acquire the user data by the magnetic sensor 113. For example, the magnetic sensor 113 can be used to detect magnetic signals associated with a magnetic field of the user's heart and corresponding to a heartbeat of the user, thereby providing heart rate data. The heart rate data can then be analyzed (e.g., by the processor 103 of the mobile device 101 or the processor 123 of the central computing device 121) to determine pulse rate and/or a heart rate variability of the user.

The electrical sensor 114 can include, for example, at least one of an electroencephalogram (EEG) electrode, an electrodermal activity (EDA) sensor, a voltage detector, a current sensor, galvanometer, any other sensor suitable for acquiring bioelectric data, or combinations thereof. In some embodiments, the mobile device 101 can acquire the user data by the electrical sensor 114. For example, the electrical sensor 114 can be used to detect EEG or EDA signals associated with a user's brain activity or galvanic skin response to determine an arousal level and/or emotional state of the user.

The audio sensor 115 can include, for example, at least one of a condenser microphone, a DC-biased microphone, an RF condenser microphone, an electret microphone, a dynamic microphone, a ribbon microphone, a carbon microphone, a piezoelectric microphone, a fiber optic microphone, a laser microphone, a MEMS microphone, or combinations thereof. In accordance with various embodiments, the audio sensor 115 can be used in conjunction with the image sensor 109 to acquire audio-visual data. In some embodiments, the mobile device 101 can acquire the user data by the audio sensor 115. For example, the audio sensor 115 can be used to detect audio signals corresponding to a vocal pattern corresponding to the user's voice. The vocal pattern can then be analyzed (e.g., by the processor 103 of the mobile device 101 or the processor 123 of the central computing device 121) to determine at least one of the user's heart rate variability or the user's emotional state. Furthermore, based on the audio data acquired by the audio sensor 115, the system 100 can, in some embodiments, determine ambient noise levels which can be associated with the event record in the memory 105, 125 for providing context to the user's physiological-emotional state. Additionally, the system 100 can further analyze the audio data acquired by the audio sensor 115 to detect or identify, for example, a genre, type, artist, or song name of any music playing in the recording. This data can be associated with the event record in the memory 105, 125 for providing context to the user's physiological-emotional state.

The text analysis module 118 can be used to analyze text entered by a user in connection with collection of the user data. In particular, text analysis can be provided to detect sentiment data in the entered text. The system 100 can then, at least partially based on the sentiment data, determine an emotional state of the user when determining physiological-emotional state. Text and sentiment data can also be associated with the event record in the memory 105, 125 for providing context to the user's physiological-emotional state.

The global positioning system (GPS) module 119 can include, for example, at least one of a GPS receiver, a map application, an assisted GPS (A-GPS) receiver, a differential GPS (DGPS) system, or combinations thereof. The GPS module 119 can be used, in accordance with various embodiments, to determine a location of the mobile device 101. In some embodiments, the GPS module 119 can be used, for example, to associate a geographic location of the user with the event record for storage in the memory 105, 125 for providing context to the user's physiological-emotional state.

In some embodiments, the location data retrieved by the GPS module 119 can be used to retrieve additional information corresponding to the geographical location from an external database 131 for association with the event record in the memory 105, 125 for providing context to the user's physiological-emotional state. For example, the geographic location data from the GPS module 119 can be provided to a weather service to acquire weather data corresponding to the geographic location. Weather data can include, for example, barometric pressure, cloud cover, temperature, pollen levels, pollution levels, humidity, solar intensity, any other weather or air quality related data, or combinations thereof. Also for example, the geographic location data from the GPS module 119 can be provided to a mapping service or application to detect a specific or type of location of the user. For example, the user can be determined to be at a nightclub, a restaurant, a landmark, a university, a business, walking on the street, in an office, at a concert hall, etc. Furthermore, a specific nightclub, restaurant, service, landmark, university, restaurant, business, office, concert hall, etc. can be identified to provide greater detail.

The network 120 can include, for example, any suitable electronic communications network, including, for example, a Local Area Network (LAN), a Wide Area Network (WAN), a near field communications (NFC) network, a Bluetooth network, or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area networks (CAN), or combinations thereof. The network 120 can be used to communicate data and/or instructions between one or more of the mobile device 101, the central computing device 121, external databases 131, or combinations thereof.

The central computing device 121 can include, for example, at least one of a desktop computer, a server, a datacenter, a cloud, a laptop computer, a cellphone, a smartphone, a personal digital assistant (PDA), a laptop, a tablet, any other electronic computing device suitable for receiving and processing user data, or combinations thereof. The processor 123 can include, for example, at least one of a microprocessor, a CPU, a field-programmable gate array (FPGA), a microcontroller, single core processors, multi-core processors, or combinations thereof. The memory 125, in accordance with various embodiments, can include, for example, at least one of a magnetic storage disk, a hard disk drive (HDD), an optical disk, flash memory, random-access memory (RAM), DRAM, SRAM, EDO RAM, a solid state drive (SSD), or combinations thereof.

The central computing device 121, in accordance with various embodiments, for example, can be a storage (e.g., database server or cloud server) service for storing one or more historical event records. In some embodiments, the central computing device 121 can host an application for operating the system 100 as part of a distributed network with the mobile phone. In some embodiments the computing device can host a social network for storing, displaying, and sharing the user data, the representation of the physiological-emotional state of the user, any additional data retrieved from the one or more external servers 131, advertisements, signage, images, videos, text, colors, hyperlinks, audio players, video players, any other audio/visual content, or combinations thereof.

The display 117 of the mobile device 101 and/or the display device 127 can each include, for example, a touchscreen, a computer monitor, a television, a light emitting diode (LED) screen, an organic LED (OLED) screen, an active matrix OLED (AMOLED) screen, a Super AMOLED screen, a liquid crystal display (LCD) screen, a thin film transistor LCD (TFT LCD), an in-plane switching LCD (IPS LCD), a cathode ray tube (CRT) screen, any other suitable display, or combinations thereof. The display 117 and/or display device 127, in accordance with various embodiments, can render the representation of the physiological-emotional state of the user in response to instructions from the mobile device 101 or the central computing device 121. In accordance with some embodiments, the display 117 and/or display device 127 can render one or more interactive interfaces for interrogating the user data and any other data corresponding to the event record, one or more of a plurality of historical event records, or combinations thereof in response to instructions from the mobile device 101 or the central computing device 121.

In some embodiments, the representation of the physiological-emotional state of the user, the interactive interfaces, or combinations thereof can be rendered by the display 117 and/or the display device 127 within a graphical user interface associated with a social network hosted by the central computing device 121. In some embodiments, the representation of the physiological-emotional state of the user, the interactive interfaces, or combinations thereof can be rendered by the display 117 and/or the display device 127 within a graphical user interface associated with a social network, website, comment section, or other user facing application hosted by a third party database 131. In such embodiments, the graphical user interface hosted by the third party database 131 can render the representation of the physiological-emotional state of the user, the interactive interfaces, or combinations thereof in response to instructions received by the third party database 131 via the communications network 120 from the central computing device 121 or the mobile device 101.

In some embodiments, the central computing device 121 or mobile device 101, in response to identifying the physiological-emotional state of the user and a geographic locations of the user (e.g., from the GPS module 119), can review one or more historical event records stored in the memory 105, 125 to identify a nearby location associated with a different physiological-emotional state experienced by the user in one or more of the historical event records. For example, if the user has an angry or anxious current physiological-emotional state, the system 100 can identify one or more geographic locations (within, for example, a preset proximity) where the user previously felt happy or calm. In such embodiments, the central computing device 121 or mobile device 101 can instruct the display 117 of the mobile device 101 (or the display device 127) to render the recommendation to the user. In some embodiments, the central computing device 121 or mobile device 101 can further instruct the display 117 of the mobile device 101 (or the display device 127) to render a map showing the recommended location(s) and/or directions for reaching the recommended location(s) either concurrently with rendering of the recommendation or in response to a user acceptance of the recommendation. It will be apparent in view of this disclosure that, in some embodiments, the recommendations can be made to the user based on historical records correlating to one or more other or additional factors such as, for example, recommending that the user move from a geographic location having bad air-quality (e.g., a high concentration of air pollutants or allergens) to a geographic location having better air quality, recommending that the user relocate to a less or more humid location, recommending that the user relocate to a quieter location, recommending that the user relocate to a dimmer or brighter location, etc.

In some embodiments, the central computing device 121 or mobile device 101, in response to identifying the physiological-emotional state of the user, can prompt the user to participate in a biofeedback exercise. For example, if the user has an angry or anxious current physiological-emotional state, the system 100 can recommend a biofeedback exercise to calm the user. In such embodiments, the central computing device 121 or mobile device 101 can instruct the display 117 of the mobile device 101 (or the display device 127) to render the recommendation to the user. In some embodiments, the central computing device 121 or mobile device 101 can further instruct the processor 103 of the mobile device 101 or the processor 123 of the central computing device 121 to execute a biofeedback application in response to a user acceptance of the recommendation. The biofeedback application would then lead the user through one or more biofeedback exercises (e.g., vagal breathing exercises) until the user achieves a desired physiological-emotional state.

In some embodiments, the central computing device 121 or mobile device 101, in response to identifying the physiological-emotional state of the user, can review one or more historical event records stored in the memory 105, 125 to identify a song or music type associated with a different physiological-emotional state experienced by the user in one or more of the historical event records. For example, if the user has an angry or anxious current physiological-emotional state, the system 100 can identify one or more songs or music types that were detected when the user previously felt happy or calm. In such embodiments, the central computing device 121 or mobile device 101 can instruct the display 117 of the mobile device 101 (or the display device 127) to render a recommendation to the user to play the song or listen to the type of music. In some embodiments, the central computing device 121 or mobile device 101 can further instruct the processor 103 of the mobile device 101 or the processor 123 of the central computing device 121 to execute a music application in response to a user acceptance of the recommendation. The music application would then play the song or type of music until the user achieves a desired physiological-emotional state.

The one or more external databases 131 can include any third-party database or third-party hosted application in accordance with various embodiments. For example, as explained above, the external databases 131 can include, for example, a mapping service or a weather service. In some embodiments, the external databases 131 can also include, for example, a third-party social network or a third-party website or application offering a comment or review feature. In such embodiments, the central computing device 121 or the mobile device 101 can transmit, for example, the representation of the physiological-emotional state of the user to the external database 131 (or to a social media network hosted on the central computing device 121) for incorporation of the representation into, for example, a social media post, a reaction to a social media post, a comment presented in a comment section, a review of a service, landmark, university, restaurant, business, etc., or combinations thereof.

In some embodiments, the central computing device 121 or the mobile device 101 can transmit an event record to the external database 131 for incorporation of contextual data along with the representation of the physiological-emotional state into, for example, a social media post or a reaction to a social media post. For example, if a user is delighted with a dining experience at a particular restaurant, the event record can, in accordance with various embodiments, contain a user location determined by the GPS module 119, an identification of the restaurant (e.g., as retrieved from a mapping application or external mapping service based on the user location), and the representation of the physiological-emotional state of the user. Thus, the central computing device 121 or the mobile device 101 can instruct a third-party social media network, a review site, or a social media network hosted on the central computing device 121 to associate the representation of the physiological-emotional state of the user with the identified restaurant based on the event record, thereby providing a physiological-emotional review of the restaurant.

In some embodiments, the external databases 131 can also include, for example, a medical database associated with a health care provider such as the user's primary care provider, the user's primary mental health provider, or any other treating medical professional or medical practice (e.g., a doctor, a surgeon, a dentist, a psychiatrist, a psychologist, a hospital, a medical practice). In such embodiments, the central computing device 121 or the mobile device 101 can transmit event records, historical event records, representations of the user's physiological-emotional state, or portions or combinations thereof to user-designated medical external databases 131 for evaluation by one or more medical professionals in connection with treatment, diagnosis, patient monitoring, or other suitable medical purposes. In some embodiments, for example, the health care provider can invite one or more patients to authorize the health care provider to receive physiological-emotional state data from a social network stored on the central computing device 121. In some embodiments, the health care provider can invite one or more patients to download a specific software application to at least one of the mobile device 101 or the central computing device 121, within which the user/patient can authorize the health care provider to receive the physiological-emotional state data.

In some embodiments, the external databases 131 can include, for example, a clinical or drug trial database. In such embodiments, the central computing device 121 or the mobile device 101 can transmit event records, historical event records, representations of the user/trial subject's physiological-emotional state, or portions or combinations thereof to a clinical or drug trial external databases 131 for evaluation by one or more medical professionals, scientists, or engineers in connection with monitoring a health status of the user/trial subject. In some embodiments, receiving real time health information such as physiological-emotional state data from the user/trial subject without requiring the user/trial subject to travel to the hospital or other site of the trial can advantageously permit more frequent feedback intervals and reduce cost (e.g., permitting a broader study encompassing a larger number of subjects for the same trial budget).

In some embodiments, the external databases 131 can also include, for example, advertisers having a relationship with the user and/or with a service used by the user (e.g., a social media network, a website, or any other service). In such embodiments, the central computing device 121 or the mobile device 101 can transmit user-approved event records, historical event records, representations of the user's physiological-emotional state, or portions or combinations thereof to advertiser external databases 131 for permitting the advertiser to present the user with more accurately targeted advertisements.

In some embodiments, a social media network hosted on the central computing device 121 can store an average of a plurality of representations of physiological-emotional states associated with each of a plurality of the advertisers, services, landmarks, universities, restaurants, businesses, etc. provided by a plurality of users. In such embodiments the central computing device 121 can be configured to offer a customized advertising discount or quantity of free advertising on the social media network for each of the plurality of the advertisers, services, landmarks, universities, restaurants, businesses, etc. In some embodiments, the discount or quantity of free advertising can be determined according to the average representation of psychological-emotional state associated with the individual service, landmark, university, restaurant, business, etc. For example, in some embodiments, to promote fostering of a healthy environment, advertisers, services, landmarks, universities, restaurants, businesses, etc. having an average representation of psychological-emotional state associated with calmness, happiness, excitement, etc. can be offered larger discounts or larger quantities of free advertising than those having an average representation of psychological-emotional state associated with anger, sadness, anxiety, stress, etc. In some embodiments, rather than looking to an average physiological-emotional state, the offer can be constructed based on a point system, wherein points are accrued for each user experiencing a psychological-emotional state associated with calmness, happiness, excitement, etc. at the respective advertiser, service, landmark, university, restaurant, business, etc.

In some embodiments, one or more of the mobile device 101, the central computing device 121, a social media network hosted on the central computing device 121, or a software application on one or both of the mobile device or the central computing device 121 can include one or more recommendation engines wherein the recommendation(s) are at least partially based on physiological-emotional data. In some embodiments, any additional information associated can also be combined with the physiological-emotional data for making the recommendation. Such additional information can include, for example, geographical information (e.g., for determining geographical compatibility, common frequently visited locations, commonly used shipping addresses, etc.), prior purchase information, or personal preference information (e.g., political affiliations, preferred activities, preferred sports teams, or other personal preferences).

In some embodiments, the recommendation engine can be used to recommend movies, music, products, restaurants, or any other activity, place, or product that may alter or improve a user's physiological-emotional state. In some embodiments, the recommendation engine can be used to determine a personal compatibility between two or more users based, at least in part, on each user's current or historical physiological-emotional state data, wherein the recommendation engine can recommend a connection between the two or more users. For example, in some embodiments a recommendation can be made for compatible users to be friends or romantic partners based on each compatible user's physiological-emotional profile. In some embodiments, the recommendation engine can be implemented, for example, to assist a user of a social network to expand a list of social network connections. In some embodiments, the recommendation engine can be implemented, for example, as an improved dating service.

In some embodiments, an application stored in, or a social network hosted on, the central computing device 121, can associate the geographic location data from the GPS module 119 and data retrieved from the mapping service with a particular representation of a physiological-emotional state recorded by a particular user. In some embodiments, the application or social network can be configured to average or aggregate a plurality of representations of physiological-emotional state recorded by a plurality of users over a period of time for each particular advertiser, service, landmark, university, restaurant, business, etc. to produce a physiological-emotional rating thereof.

In some embodiments, the application or social network hosted on the central computing device 121 can provide an augmented reality interface for interactive display on the mobile device 101. In some embodiments, the augmented reality interface can provide a user with an image of a geographical location overlaid by a plurality of representations of physiological-emotional state to inform the user's interactions with the geographical location, any advertiser, service, landmark, university, restaurant, business, etc., or any person located within the geographical location. In some embodiments, the augmented reality interface can provide one or more of a two-dimensional map, a three-dimensional map, or a photographic or video-based representation of the geographical location for overlayment with representations of physiological emotional data.

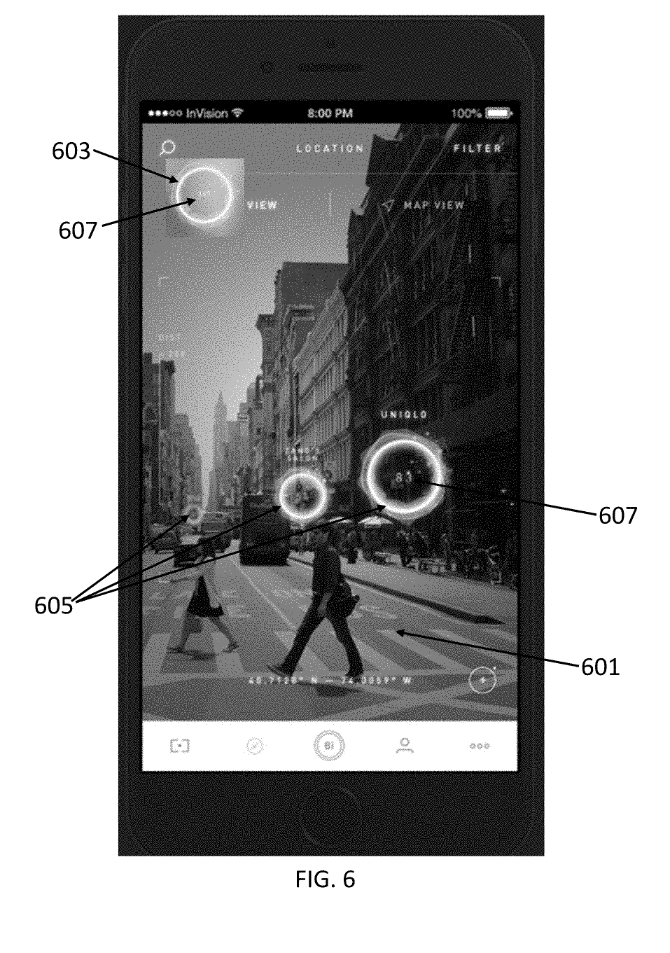

As shown in FIG. 6, an augmented reality interface, in accordance with various embodiments, can include real time imagery or video of a current geographical location 601 of the user. The imagery or video 601 is then overlaid with a plurality of representations of physiological-emotional state 603, 605. In some embodiments, a representation of a physiological-emotional state associated with the overall geographic location 603 can be provided. In some embodiments, the physiological-emotional state of the overall geographic location 603 can include a representation of long-term average physiological-emotional state and/or a real-time instantaneous physiological-emotional state. By viewing the long-term average, the user can determine whether or not the overall geographic location is typically enjoyable. By viewing the instantaneous physiological-emotional state, the user can detect a temporary or aberrant positive or negative event (e.g., a traffic accident, a traffic jam, a parade, or a crime in process) is occurring and plan accordingly.

In some embodiments, representations of physiological-emotional states associated with one or more specific locations 605 (e.g., as discussed with greater detail herein above) such as a nightclub, a restaurant, a service, a landmark, a university, a restaurant, a business, an office, a concert hall, etc. can be provided. In some embodiments, the representation of physiological-emotional state of each specific location 605 can aid the user in selecting where to, for example, shop, eat, play, view a show, get away to go calm down, or otherwise engage in or disengage from an activity.

In accordance with various embodiments, the representations of physiological-emotional state 603, 605 can include a center portion 607 for presenting one or more of advertisements, signage, images, videos, text, colors, hyperlinks, audio players, video players, any other audio/visual content, or combinations thereof to users.

In some embodiments, representations of physiological-emotional states associated with one or more specific individuals (not shown) located in the overall geographic location can be provided. For example, in some embodiments, each user of the social network can elect to show that user's most recent representation of physiological-emotional state to other users, upon inquiry by the other users'augmented reality interface. In some embodiments, the representation of physiological-emotional state of each specific individual can aid the user in selecting whom to interact with and/or how to approach or interact with such individuals.

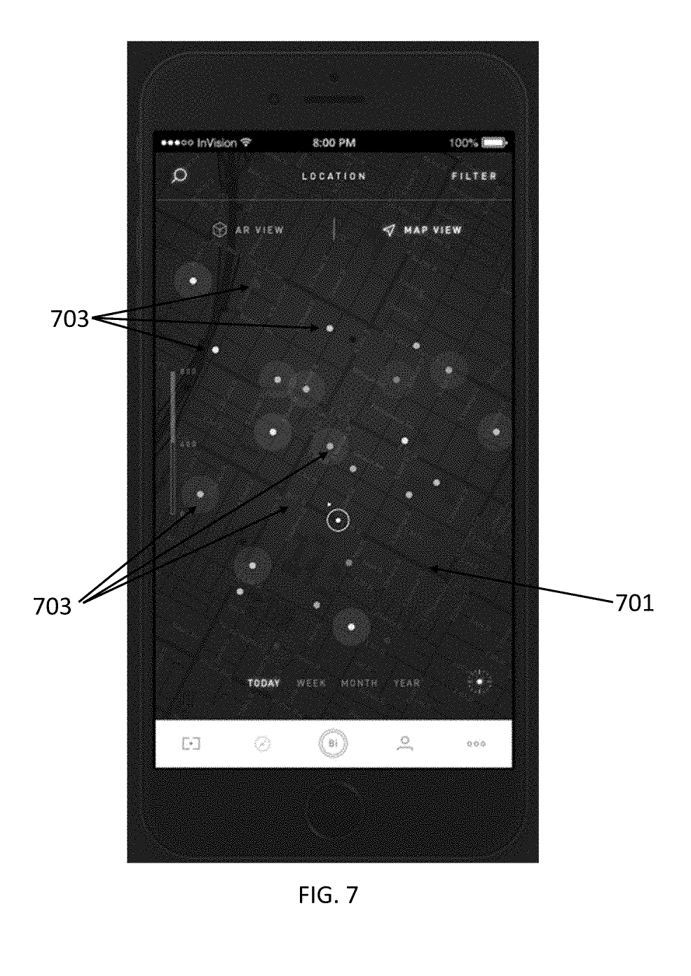

As shown in FIG. 7, a map interface 701, in accordance with various embodiments, can include a map surrounding a current or manually-specified geographical location 701 of the user. The map interface 701 is then overlaid with a plurality of representations of physiological-emotional state 703. In some embodiments, a representation of a physiological-emotional state 703 associated with a geographic location can be provided. In some embodiments, the physiological-emotional state of the geographic location 703 can include a representation of long-term average physiological-emotional state and/or a real-time instantaneous physiological-emotional state. By viewing the long-term average, the user can determine whether or not the geographic location is typically enjoyable. By viewing the instantaneous physiological-emotional state, the user can detect a temporary or aberrant positive or negative event (e.g., a traffic accident, a traffic jam, a parade, or a crime in process) is occurring and plan accordingly. The geographic location can, in accordance with various embodiments, include an overall geographic location (e.g., a block, a neighborhood, a town, a city, a state, or a country) or the geographic location can include one or more specific locations (e.g., as discussed with greater detail herein above) such as a nightclub, a restaurant, a service, a landmark, a university, a restaurant, a business, an office, a concert hall, etc. The representation of physiological-emotional state of each geographic location 703 can, in accordance with various embodiments, aid the user in selecting where to, for example, shop, eat, play, view a show, get away to go calm down, or otherwise engage in or disengage from an activity. In some embodiments, the representations of physiological-emotional state 703 can correspond to individual users to aid the user in determining a current physiological-emotional state of a user currently located within a geographic area encompassed by the map interface 701.

As shown in FIG. 7, in one embodiment, the graphical representation of physiological-emotional state 703 can include a colored dot, wherein a size, color, and/or intensity of the dot can indicate the physiological-emotional state of the user or users. Also as shown in FIG. 7, in one embodiment, the graphical representation of physiological-emotional state 703 can include a pulsing or flashing colored dot, wherein a size, color, and/or intensity of the dot can indicate the physiological-emotional state of one or more individual users located within the geographic area encompassed by the map interface 701. In some embodiments, the pulse or flash rate of the colored dot can correspond to a physiological and/or emotional measurement associated with each user (e.g., heart rate).

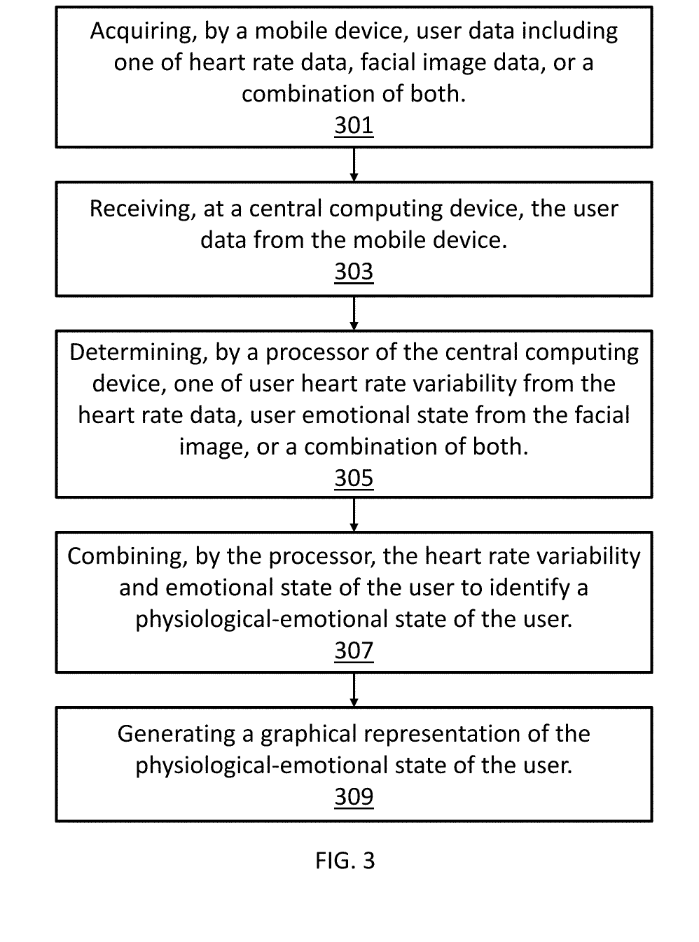

Referring now to FIG. 3, in accordance with various embodiments, a method 300 is provided herein for measuring a physiological-emotional state of a user. The method includes the step of acquiring 301, by a mobile device, user data including one of heart rate data, facial image data, or a combination of both. The method also includes the step of receiving 303, at a central computing device, the user data from the mobile device. The method also includes the step of determining 305, by a processor of the central computing device, one of user heart rate variability from the heart rate data, user emotional state from the facial image, or a combination of both. The method also includes the step of combining 307, by the processor, the heart rate variability and emotional state of the user to identify a physiological-emotional state of the user. The method also includes the step of generating 309 a graphical representation of the physiological-emotional state of the user.

The step of acquiring 301, in accordance with various embodiments, can be performed, for example, but not limited to, by acquiring heart rate data and/or emotional state data using one or more of the image sensor 109, the light source 111, the magnetic sensor 113, the audio sensor 115, or combinations thereof of the mobile device 101 as described above with reference to FIG. 1. The step of receiving 303, in accordance with various embodiments, can be performed, for example, but not limited to, transmitting, using the communications device 107 of the mobile device 101, the user data to the central computing device 121 as described above with reference to FIG. 1.

The step of determining 305, in accordance with various embodiments, can be performed, for example, but not limited to, by using the processor 123 and memory 125 of the central computing device 121 to analyze the user data as described above with reference to FIG. 1.

The step of combining 307, in accordance with various embodiments, can be performed, for example, but not limited to, by using the processor 123 and memory 125 of the central computing device 121 to synthesize the determined HRV and emotional state of the user as described above with reference to FIG. 1.

The step of generating 309, in accordance with various embodiments, can be performed, for example, but not limited to, by using the processor 123 and memory 125 of the central computing device 121 to create one or more of a graphical, pictorial, animated, or auditory representation of the synthesized HRV and emotional state (i.e., a physiological-emotional state) of the user as described above with reference to FIG. 1.

At least some aspects disclosed can be embodied, at least in part, in software. That is, the techniques may be carried out in a special purpose or general purpose computer system or other data processing system in response to its processor, such as a microprocessor, executing sequences of instructions contained in a memory, such as ROM, volatile RAM, non-volatile memory, cache or a remote storage device. Functions expressed in the claims may be performed by a processor in combination with memory storing code and should not be interpreted as means-plus-function limitations.

Routines executed to implement the embodiments may be implemented as part of an operating system, firmware, ROM, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

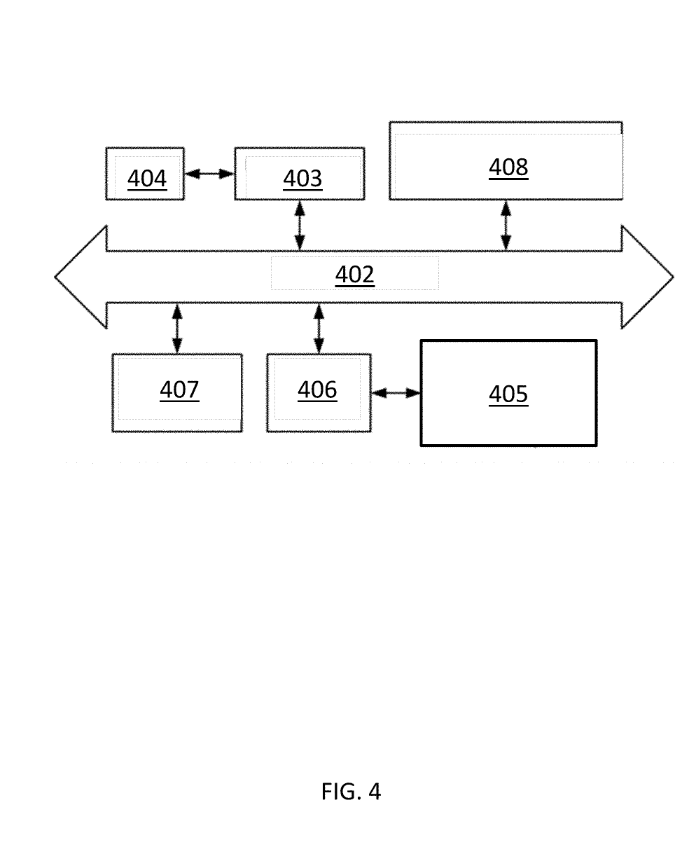

FIG. 4 shows a block diagram of a data processing system that can be used in various embodiments of the disclosed systems and methods. While FIG. 4 illustrates various components of a computer system, it is not intended to represent any particular architecture or manner of interconnecting the components. Other systems that have fewer or more components may also be used.

In FIG. 4, the system 401 includes an inter-connect 402 (e.g., bus and system core logic), which interconnects a microprocessor(s) 403 and memory 408. The microprocessor 403 is coupled to cache memory 404 in the example of FIG. 4.

The inter-connect 402 interconnects the microprocessor(s) 403 and the memory 408 together and also interconnects them to a display controller and display device 407 and to peripheral devices such as input/output (I/O) devices 405 through an input/output controller(s) 406. Typical I/O devices include mice, keyboards, modems, network interfaces, printers, scanners, video cameras and other devices that are well known in the art.

The inter-connect 402 may include one or more buses connected to one another through various bridges, controllers and/or adapters. In one embodiment the I/O controller 406 includes a USB (Universal Serial Bus) adapter for controlling USB peripherals, and/or an IEEE-1394 bus adapter for controlling IEEE-1394 peripherals.

The memory 408 may include ROM (Read-Only Memory), and volatile RAM (Random Access Memory) and non-volatile memory, such as hard drive, flash memory, etc.

Volatile RAM is typically implemented as dynamic RAM (DRAM) that requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In an embodiment, the various servers supporting the platform are implemented using one or more data processing systems as illustrated in FIG. 4. In an embodiment, user devices such as those used to access the user interfaces shown in FIG. 4-15 and Appendices A and B are implemented using one or more data processing system as illustrated in FIG. 4.

In some embodiments, one or more servers of the system illustrated in FIG. 4 are replaced with the service of a peer-to-peer network or a cloud configuration of a plurality of data processing systems, or a network of distributed computing systems. The peer-to-peer network, or cloud based server system, can be collectively viewed as a server data processing system.

Embodiments of the disclosure can be implemented via the microprocessor(s) 403 and/or the memory 408. For example, the functionalities described above can be partially implemented via hardware logic in the microprocessor(s) 403 and partially using the instructions stored in the memory 408. Some embodiments are implemented using the microprocessor(s) 403 without additional instructions stored in the memory 408. Some embodiments are implemented using the instructions stored in the memory 408 for execution by one or more general-purpose microprocessor(s) 403. Thus, the disclosure is not limited to a specific configuration of hardware and/or software.

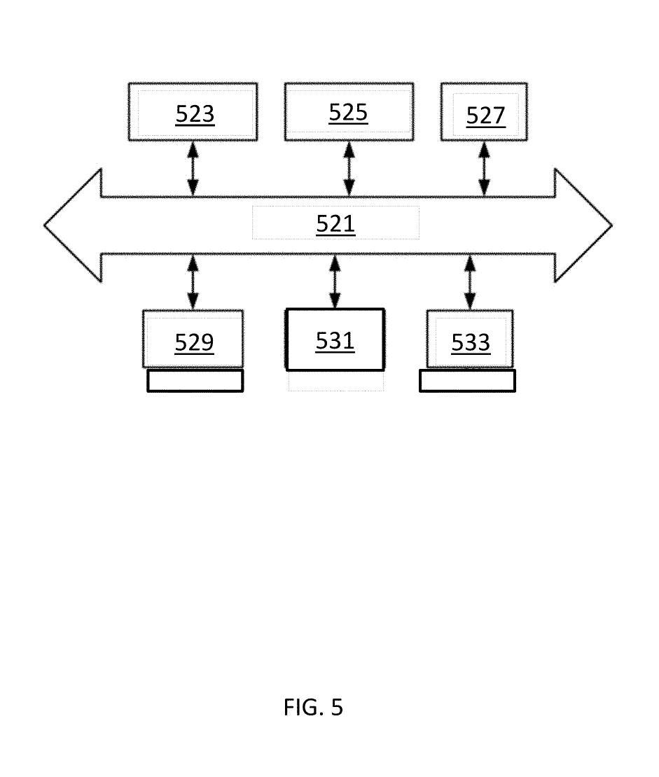

FIG. 5 shows a block diagram of a user device. In FIG. 5, the user device includes an inter-connect 521 connecting a communication device 523, such as a network interface device, a presentation device 529, such as a display screen, a user input device 531, such as a keyboard or touch screen, user applications 525 implemented as hardware, software, firmware or a combination of any of such media, such various user applications (e.g. apps), a memory 527, such as RAM or magnetic storage, and a processor 533 that, inter alia, executes the user applications 525.

In one embodiment, the user applications implement one or more user interfaces displayed on the presentation device 529 that provides users the capabilities to, for example, access the Internet, and display and interact with user interfaces provided by the platform, such as, for example the user interfaces shown in FIG. 1. In one embodiment, the user applications use the communication device to communicate with the central computer 121 via the network 120 as shown in FIG. 1.

In one embodiment, users use the user input device 531 to interact with the device via the user applications 525 supported by the device, for example, by recording or otherwise using mobile device 101 to acquire user data, as described in detail above with respect to FIGS. 1-3. The user input device 531 may include a text input device, a still image camera, a video camera, and/or a sound recorder, etc.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

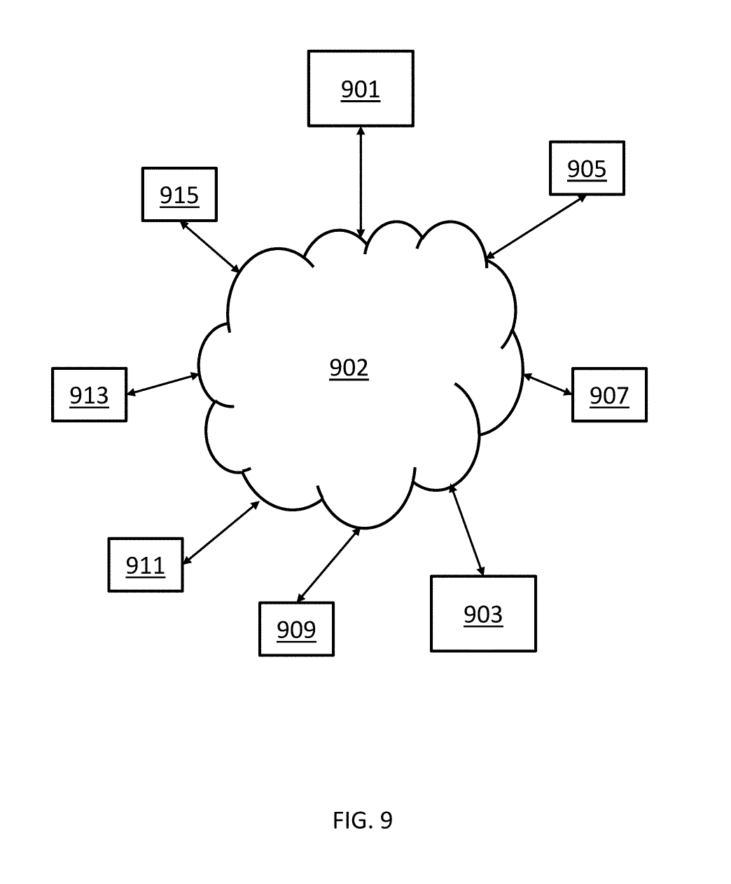

Referring now to FIG. 9, an exemplary embodiment of a system for measuring a physiological-emotional state of a user is shown. The system includes a mobile device 901 for communication, via network 902, with a central computing device 903 or cloud. As shown, each of the mobile device and the central computing device can communicate with a plurality of third party databases, applications, and application program interfaces (API) to augment or perform various functions within the application.

For example, a first API 905 can be used to authenticate the user and draw email and/or friend list information regarding the user. A second API 907 can be used to set up a user profile and to store user personal information (e.g., phone number, address, and email information).

Audio data can be processed using, for example, a third API 909 to perform voice analysis (e.g., analysis of the user's voice) and a fourth API 911 can analyze audio data to detect and/or identify a song within the audio data. A fifth API 913 can supplement geolocation by identifying an advertiser, service, landmark, university, restaurant, business, etc. Environmental data such as music or movie data can be retrieved and/or reported using, for example a sixth API 915. It will be apparent in view of this disclosure that any number of different or additional third party databases, systems, or applications can be used in accordance with various embodiments.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention. The above description and drawings are merely illustrative of the present invention and that changes in components, structure and procedure are possible without departing from the scope of the present invention as defined in the following claims. For example, elements and/or steps described above and/or in the following claims in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

What is claimed is:

1. A method comprising:
acquiring, by a mobile device, user data including one of physiological data, emotional affect data, or a combination of both;
receiving, at a central computing device, the user data from the mobile device;
determining, by a processor of the central computing device, a user state from the physiological data, the emotional affect data, or a combination of both;
quantifying, by the processor, the user state to identify a physiological-emotional state of the user; and
presenting a graphical representation of the physiological-emotional state of the user on a display device.

2. The method of claim 1, further comprising instructing the display device in electronic communication with the central computing device to render the graphical representation of the physiological-emotional state of the user within a graphical user interface displayed on the display device.

3. The method of claim 1, further comprising instructing, via a communications network, a third party server in electronic communication with the central computing device to render the graphical representation of the physiological-emotional state of the user within a graphical user interface generated by the third party server.

4. The method of claim 1, wherein the user data includes one or more of emotional affect, valence, heart rate variability (HRV), arousal level, heart rate, user body temperature, electrical brain activity data, vocal pattern data, electrodermal activity, variation in pupil dilation, fluctuations in skin tone or coloration, fluctuations in blood pressure, or combinations thereof.

5. The method of claim 1, wherein the step of acquiring the user data includes:
illuminating, by a light source of the mobile device, a finger of the user;
recording, by an image sensor of the mobile device, video of the illuminated finger of the user;
detecting a pulse of the user within the video of the illuminated finger; and
calculating a heart rate variability corresponding to the pulse of the user.

6. The method of claim 1, wherein the step of acquiring the user data includes detecting, by a magnetic sensor of the mobile device, magnetic signals corresponding to a heartbeat of the user.

7. The method of claim 1, wherein the step of acquiring the user data includes capturing, by an image sensor of the mobile device, an image of the face of the user.

8. The method of claim 1, wherein the step of acquiring the user data includes recording, by an image sensor of the mobile device, video of the face of the user.

9. The method of claim 8, wherein the step of acquiring the user data includes:
detecting a pulse of the user within the video of the face of the user; and
calculating a heart rate variability corresponding to the pulse of the user.

10. The method of claim 1, the user data further including audio data corresponding to a voice of the user, the method further comprising:
determining, by the processor and from the audio data, one of user heart rate variability, a change in vocal pattern, a user emotional affect, or combinations thereof corresponding to a vocal pattern associated with the voice of the user.

11. The method of claim 1, further comprising storing, in a memory of the central computing device, an event record including the user data, the physiological-emotional state of the user, and a time stamp associated with a time of acquisition of the user data.

12. The method of claim 11, further comprising:
detecting, by a GPS module of the mobile device, a geographic location of the user; and
associating, in the memory of the central computing device, the geographic location of the user with the event record.

13. The method of claim 12, further comprising:
identifying, by the mobile device, at least one environmental factor present during acquisition of the user data; and
associating, in the memory of the central computing device, the at least one environmental factor with the event record.

14. The method of claim 13, wherein the at least one environmental factor includes one or more of an ambient temperature, ambient colors, location-specific weather data, location-specific air quality data, ambient noise level, ambient noise type, recent user activity, contemporaneous user activity, planned subsequent user activity, or combinations thereof.

15. The method of claim 13, wherein the memory includes a plurality of historical event records, the method further comprising:
identifying at least one of the historical event records associated with a second physiological-emotional state experienced by the user at a corresponding historical geographic location, wherein the corresponding historical geographic location is within a preset proximity to the geographic location of the user; and
instructing a display of the mobile device to render a graphical representation of the second physiological-emotional state and a recommendation to the user to relocate to the historical geographic location to change the physiological-emotional state of the user.

16. The method of claim 15 further comprising instructing the display of the mobile device to render a graphical representation of the historical geographic location in response to a user acceptance of the recommendation.

17. The method of claim 11, further comprising transmitting the event record to one or more user-selected medical health professional databases in electronic communication with the central computing device.

18. The method of claim 11, further comprising instructing a display device in electronic communication with the central computing device to render interactive interfaces for interrogating the user data corresponding to the event record, one or more of a plurality of historical event records, or combinations thereof.

19. A system comprising:
a mobile device configured to acquire user data including one of physiological data, emotional affect data, or a combination of both; and
a central computing device configured to receive the user data from the mobile device, the central computing device including:
a processor; and
a memory, the memory including instructions that, when executed by the processor, cause the system to:
determine a user state from the physiological data, the emotional affect data, or a combination of both;
quantify, by the processor, the user state to identify a physiological-emotional state of the user; and
present a graphical representation of the physiological-emotional state of the user on a display device.

20. The system of claim 19, wherein the user data includes one or more of emotional affect, valence, heart rate variability (HRV), arousal level, heart rate, user body temperature, electrical brain activity data, vocal pattern data, electrodermal activity, variation in pupil dilation, fluctuations in skin tone or coloration, fluctuations in blood pressure, or combinations thereof.

21. The system of claim 19, further comprising:
the display device in electronic communication with the central computing device,
wherein the memory includes instructions that, when executed by the processor, cause the system to instruct the display device to render the graphical representation of the physiological-emotional state of the user within a graphical user interface displayed on the display device.

22. The system of claim 19, wherein the memory includes instructions that, when executed by the processor, cause the system to instruct, via a communications network, a third party server in electronic communication with the central computing device to render the graphical representation of the physiological-emotional state of the user within a graphical user interface generated by the third party server.

23. The system of claim 19, the mobile device including:
a light source; and
an image sensor,
wherein the memory includes instructions that, when executed by the processor, cause the system to:
illuminate, by the light source, a finger of the user;
record, by the image sensor, video of the illuminated finger of the user;
detect a pulse of the user within the video of the illuminated finger; and
calculate a heart rate variability corresponding to the pulse of the user.

24. The system of claim 19, the mobile device including:
a magnetic sensor,
wherein the memory includes instructions that, when executed by the processor, cause the system to detect, by the magnetic sensor, magnetic signals corresponding to a heartbeat of the user.

25. The system of claim 19, the mobile device including:
an image sensor,
wherein the memory includes instructions that, when executed by the processor, cause the system to capture, by the image sensor, an image of the face of the user.

26. The system of claim 19, the mobile device including:
an image sensor,
wherein the memory includes instructions that, when executed by the processor, cause the system to record, by the image sensor, video of the face of the user.

27. The system of claim 26, wherein the memory includes instructions that, when executed by the processor, cause the system to:
detect a pulse of the user within the video of the face of the user; and
calculate a heart rate variability corresponding to the pulse of the user.

28. The system of claim 19, the mobile device including:
an audio sensor,
wherein the memory includes instructions that, when executed by the processor, cause the system to:
record, by the audio sensor, audio data corresponding to a voice of the user, and
determine, from the audio data, one of user heart rate variability, a user emotional state, or a combination of both corresponding to a vocal pattern associated with the voice of the user.

29. The system of claim 19, wherein the memory includes instructions that, when executed by the processor, cause the system to store, in the memory, an event record including the user data, the physiological-emotional state of the user, and a time stamp associated with a time of acquisition of the image data and the heart rate data.

30. The system of claim 28, the mobile device including:
a GPS module,
wherein the memory includes instructions that, when executed by the processor, cause the system to:
detect, by the GPS module, a geographic location of the user; and
associate, in the memory, the geographic location of the user with the event record.

31. The system of claim 30, wherein the memory includes instructions that, when executed by the processor, cause the system to:
identify, by the mobile device, at least one environmental factor present during acquisition of the user data; and
associate, in the memory, the at least one environmental factor with the event record.

32. The system of claim 31, wherein the at least one environmental factor includes one or more of an ambient temperature, ambient colors, location-specific weather data, location-specific air quality data, ambient noise level, ambient noise type, recent user activity, contemporaneous user activity, planned subsequent user activity, or combinations thereof.

33. The system of claim 31, the mobile device including:
a display,
wherein the memory includes instructions that, when executed by the processor, cause the system to:
identify at least one of the historical event records associated with a second physiological-emotional state experienced by the user at a corresponding historical geographic location, wherein the corresponding historical geographic location is within a preset proximity to the geographic location of the user; and
instruct the display of the mobile device to render a graphical representation of the second physiological-emotional state and a recommendation to the user to relocate to the historical geographic location to change the physiological-emotional state of the user.

34. The system of claim 33 wherein the memory includes instructions that, when executed by the processor, cause the system to instruct the display of the mobile device to render a graphical representation of the historical geographic location in response to a user acceptance of the recommendation.

35. The system of claim 29, wherein the memory includes instructions that, when executed by the processor, cause the system to transmit the event record to one or more user-selected medical health professional databases in electronic communication with the central computing device.

36. The system of claim 29, further comprising:
a display device in electronic communication with the central computing device,
wherein the memory includes instructions that, when executed by the processor, cause the system to instruct the display device to render interactive interfaces for interrogating the user data corresponding to the event record, one or more of a plurality of historical event records, or combinations thereof.

37. A social networking system comprising:
a plurality of mobile devices each including:
one or more of a an image sensor, a video sensor, a magnetic sensor, an audio sensor, an electrical sensor, or combinations thereof to acquire user data from a plurality of users including one of physiological data, emotional affect data, or a combination of both; and
a GPS module; and
a central computing device, the central computing device including:
a transceiver for receiving the user data from the plurality of mobile devices;
a processor; and
a memory, the memory including instructions that, when executed by the processor, cause the system to:
detect, by the GPS module of each of the plurality of mobile devices, a geographic location of each of the plurality of users,
determine, for each of the plurality of users, a user state from one of the physiological data, the emotional affect data, or a combination of both,
combine, by the processor, the geographic location and the user state of each of the plurality of users to identify a location-specific physiological-emotional state of each of the plurality of users,
averaging the physiological-emotional states of each of the plurality of users for each of the plurality of geographic locations to establish a plurality of average location-specific physiological-emotional states of the plurality of users, and
presenting a graphical representation of at least one of the plurality of average location-specific physiological-emotional states of the plurality of users on a display device.

38. The system of claim 37, wherein the user data includes one or more of emotional affect, valence, heart rate variability (HRV), arousal level, heart rate, user body temperature, electrical brain activity data, vocal pattern data, electrodermal activity, variation in pupil dilation, fluctuations in skin tone or coloration, fluctuations in blood pressure, or combinations thereof.

39. The system of claim 37, further comprising:
the display device in electronic communication with the central computing device; and
a mapping service for generating a geographical map,
wherein the memory includes instructions that, when executed by the processor, cause the system to instruct the display device to render, at a location within the geographical map corresponding to the geographical location of the plurality of users, the graphical representation of the at least one of the plurality of average location-specific physiological-emotional states of the plurality of users within a graphical user interface displayed on the display device.

40. The system of claim 39, further comprising:
an augmented reality module,
wherein the memory includes instructions that, when executed by the processor, cause the augmented reality module to:
capture at least one image using one or more of the image sensor or the video sensor of the mobile device;
display, on the display device, at a location within the at least one image corresponding to the geographical location of the plurality of users, the graphical representation of the at least one of the plurality of average location-specific physiological-emotional states of the plurality of users within a graphical user interface displayed on the display device.

41. The system of claim 37, wherein the memory includes instructions that, when executed by the processor, cause the system to instruct, via a communications network, a third party server in electronic communication with the central computing device to render, within a geographical map, the graphical representation of the at least one of the plurality of average location-specific physiological-emotional states of the plurality of users within a graphical user interface displayed on the display device within a graphical user interface generated by the third party server.

42. The system of claim 40, wherein the memory includes instructions that, when executed by the processor, cause the augmented reality module to display, within a graphical user interface displayed on the display device, one or more of advertisements, signage, images, videos, text, colors, hyperlinks, audio players, video players, any other audio/visual content, or combinations thereof within the graphical representation of the at least one of the plurality of average location-specific physiological-emotional states of the plurality of users.
